(19) United States
(12) Patent Application Publication
(10) Pub. No.: US 2018/0152072 A1
(43) Pub. Date: May 31, 2018

(54) RESOLVER

(71) Applicant: MINEBEA MITSUMI Inc., Nagano (JP)

(72) Inventor: Haruki OTOBE, Toyota-shi (JP)

(21) Appl. No.: 15/877,559

(22) Filed: Jan. 23, 2018

Related U.S. Application Data
(63) Continuation of application No. PCT/JP2016/072043, filed on Jul. 27, 2016.

(30) Foreign Application Priority Data
Jul. 31, 2015 (JP) 2015-152464

(51) Int. Cl. H02K 5/08; G01D 5/20; H02K 1/16

(52) U.S. Cl. CPC H02K 5/08; H02K 1/16; G01D 5/20

(57) ABSTRACT

Provided is a resolver including: a stator core including teeth; an insulator attached to the stator core; windings wound around the respective teeth; a terminal pin base formed integrally with an insulator and extending in a radial direction of the resolver; terminal pins arranged in the terminal pin base and having end parts of the respective windings connected thereto. A surface treatment layer is formed on a surface of the stator core. A resin layer is formed of molding resin that covers the windings and the terminal pins, and the windings and the terminal pins are sealed within the resin layer.

### CROSS-REFERENCE TO RELATED APPLICATIONS

This application is a continuation of International Application No. PCT/JP2016/072043, filed on Jul. 27, 2016 which claims the benefit of priority of the prior Japanese Patent Application No. 2015-152464, filed on Jul. 31, 2015, the entire contents of which are incorporated herein by reference.

### FIELD

The present invention relates to a resolver that is excellent in properties related to environmental durability such as water proofing, oil proofing, vibration resistance, and shock resistance.

### BACKGROUND

Resolvers are known as tools to detect rotation angles. A resolver includes a rotor that is fixed to a rotating shaft of a motor or the like and rotates, and a stator that is fixed to the housing or the like and arranged so as to face the rotor in a radial direction of the stator. The stator has excitation windings and detection windings wound therearound, and the detection winding is composed of a winding that outputs a sine signal and a winding that outputs a cosine signal. With excitation current applied to the excitation windings, the rotor of the resolver rotates. As a result, the width of the gap formed between the rotor and the stator changes, and voltage corresponding to this change is induced to each detection winding. The voltage induced to the detection winding is a signal in which the rotation angle of the rotor is reflected, and this signal can be used to detect the angle of the rotating shaft of the motor and the like.

The terminals of the respective excitation windings and the respective detection windings are connected to terminal pins implanted in a terminal pin base part formed integrally with an insulator. Conventionally, a resolver has been proposed that has the external surfaces of windings treated with resin molding and thus covered with molding resin for protecting the windings (see, for example, Japanese Laid-open Patent Publication No. 2002-171737).

FIG. 5 is a variable reluctance (VR) resolver 200 disclosed in Japanese Laid-open Patent Publication No. 2002-171737. FIG. 6 is a sectional view illustrating a section taken along the M-N line in FIG. 5. The VR resolver 200 includes a stator assembly having an annular stator core 201 sandwiched between a first stator magnetic-pole assembly 205 and a second stator magnetic-pole assembly 206, the stator core 201 being composed of soft magnetic plates, the first stator magnetic-pole assembly 205 having a part attachment portion 207. The stator core 201, the first stator magnetic-pole assembly 205, and the second stator magnetic-pole assembly 206 are surrounded by synthetic resin 211 in a manner such that surfaces of magnetic-pole teeth 204 of the stator core 201 that face a rotor are exposed, so that stator windings 208 are covered with the synthetic resin 211.

In a structure illustrated in FIG. 5, the stator core 201 is, in general, constructed of a plurality of soft magnetic plates, each formed in a certain shape by press work, stacked and swaged together to be fixed to one another. In Japanese Laid-open Patent Publication No. 2002-171737, however, the magnetic-pole teeth 204 of the stator core 201 facing the rotor, and the outer circumferential surface of the stator core 201 are not covered with the synthetic resin 211. For this reason, because of wetting by moisture in an environment in which the resolver is used, moisture rusts the outer circumferential surfaces and exposed portions of the magnetic-pole teeth 204 of the stator core 201 that are not covered with the synthetic resin 211. In addition, moisture intrudes between the stacked cores of the stator core 201 and rusts the inside of the stator core 201.

### SUMMARY

A resolver according to an embodiment includes a stator core including teeth, an insulator attached to the stator core, windings wound around the respective teeth with the insulator interposed between each of the windings and a corresponding one of the teeth, a terminal pin base formed integrally with the insulator and extending in a radial direction of the resolver, and terminal pins arranged in the terminal pin base and having end parts of the respective windings connected thereto. A surface treatment layer is formed on a surface of the stator core. A resin layer is formed of molding resin that covers the windings and the terminal pins. The windings and the terminal pins are sealed within the resin layer.

### BRIEF DESCRIPTION OF THE DRAWINGS

FIG. 1 is a perspective view illustrating a resolver according to an embodiment;

FIG. 2 is a perspective view illustrating a stator yet to have resin layers of molding resin formed thereon;

FIG. 3 is an exploded perspective view of the stator in FIG. 2;

FIG. 4 is a partial sectional view of FIG. 1;

FIG. 5 is a view illustrating a stator assembly of a conventional resolver; and

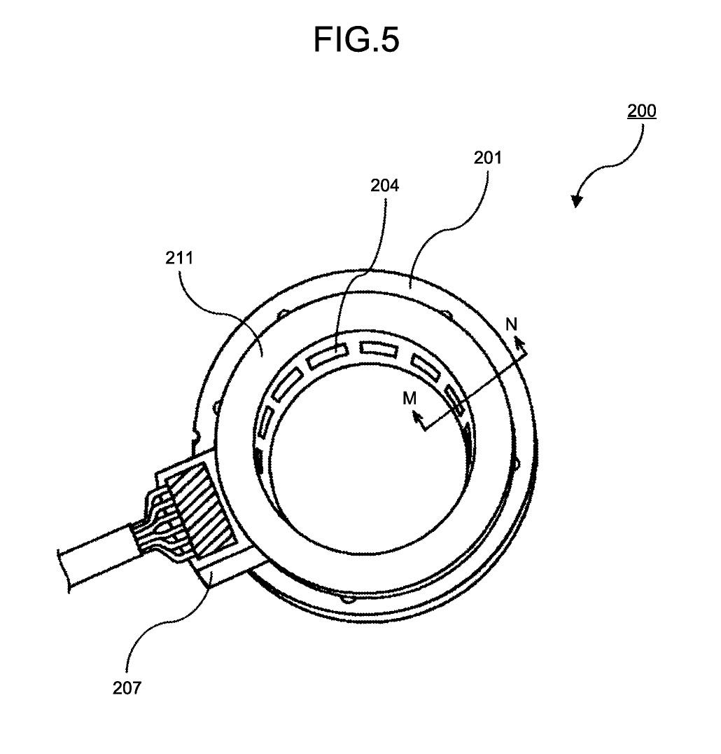

FIG. 6 is a sectional view taken along the M-N line in FIG. 5.

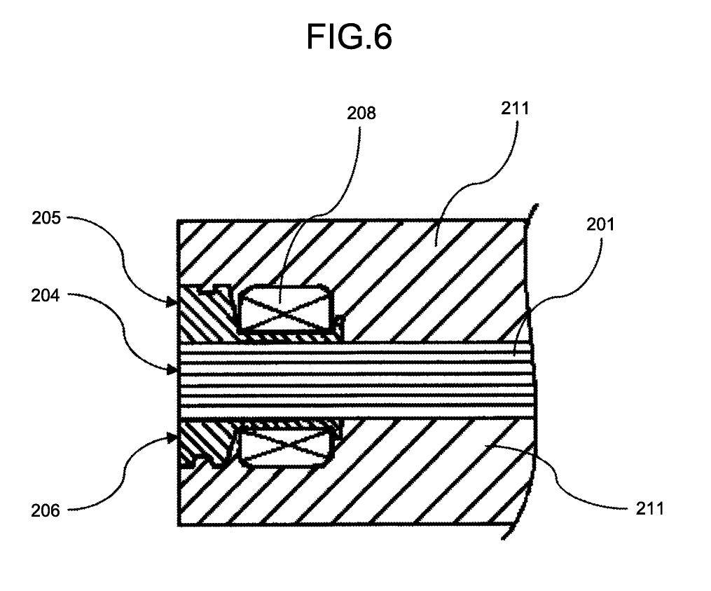

### DETAILED DESCRIPTION

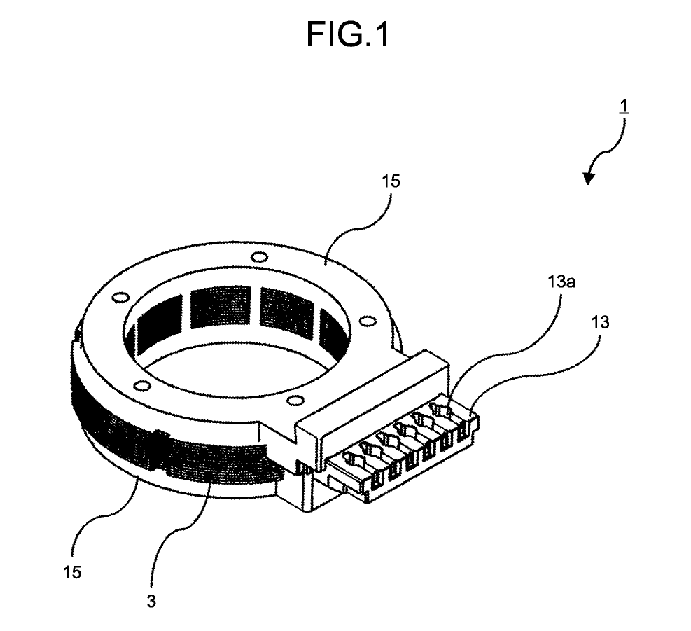

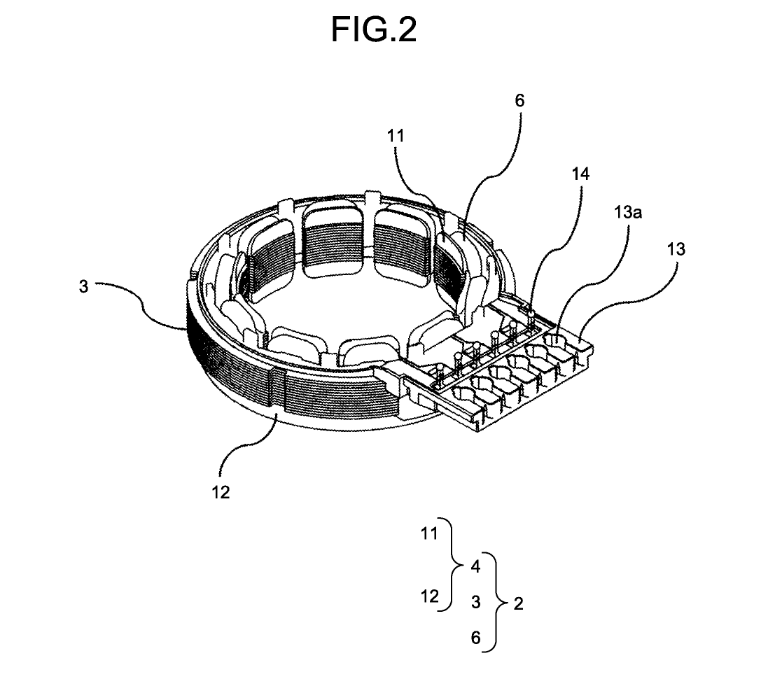

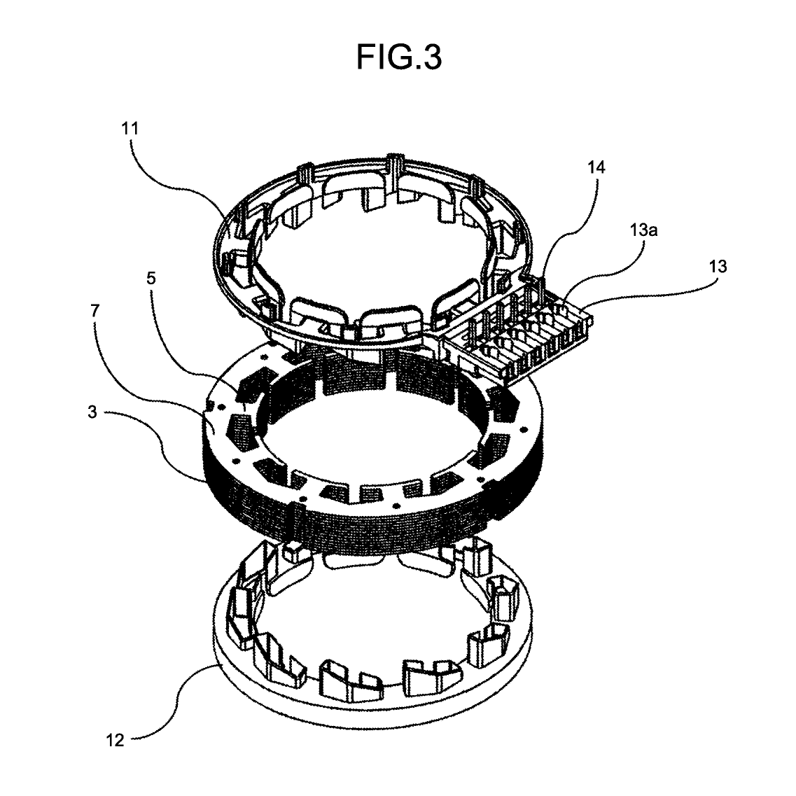

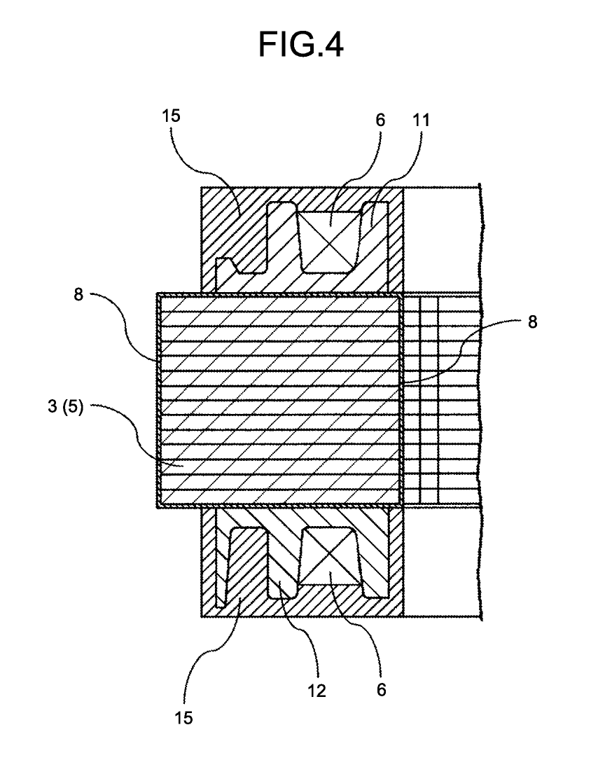

FIG. 1 is a perspective view of a resolver according to an embodiment. FIG. 2 is a perspective view illustrating a stator yet to have resin layers of molding resin formed thereon as illustrated in FIG. 1. FIG. 3 is an exploded perspective view of the stator in FIG. 2. FIG. 4 is a partial sectional view illustrating a section of a part in FIG. 1 that includes the resin layer.

FIG. 1 illustrates an inner-rotor type variable reluctance (VR) resolver 1. The VR resolver 1 includes a stator 2. A rotor (not illustrated) is placed inside the stator 2. The rotor is constructed of a plurality of soft magnetic cores stacked on each other, and is fixed to a rotating shaft of the motor or the like (not illustrated).

The stator 2 includes: a stator core 3 formed of a plurality of thin-plate shaped, soft magnetic cores stacked on each other; a resin insulator 4 attached to the stator core 3; and windings 6 wound around teeth 5 (see FIG. 3) of the stator core 3 with the insulator 4 interposed between each of the windings 6 and a corresponding one of the teeth 5.

As illustrated in FIG. 3, the thin-plate shaped, soft magnetic cores included in the stator core 3 have a plurality of teeth 5 (10 teeth in this embodiment) extending radially inward from an annular yoke section 7. The stator core 3 is constructed by swaging and fixing a plurality of such thin-plate cores to one another with these cores rotated and stacked on one another.

As illustrated in FIG. 4, surface treatment (such as electrodeposition coating, electrostatic powder coating, or plating) is applied to the stator core 3 after the swaging fixation, so that a surface treatment layer 8 is formed to prevent the soft magnetic cores from being exposed. The outer circumferential surface and the inner circumferential surface of the annular stator core 3 are kept from being directly exposed by the presence of the surface treatment layer 8. The surface treatment layer 8 needs only be formed at least in parts through which the stator core 3 are exposed after the formation of resin layers 15 by injection of molding resin (described below).

As illustrated in FIG. 3, a first insulator 11 is attached to the stator core 3 from the one end of the stator core 3 in the axial direction thereof, and a second insulator 12 is attached to the stator core 3 from the other end of the stator core 3 in the axial direction thereof. Subsequently, as illustrated in FIG. 2, the respective windings 6 are wound around all of the teeth 5 (see FIG. 3) with the insulator 4, composed of the first insulator 11 and the second insulator 12, interposed between each of the windings 6 and a corresponding one of the teeth 5. The windings 6 are composed of excitation windings and detection windings. The excitation windings are wound around all of the teeth 5, and the detection windings are wound around certain ones of the teeth 5 with the excitation winding already wound therearound. The detection windings are composed of two detection windings, that is, a winding that outputs a sine signal and another winding that outputs a cosine signal. These windings are wound around certain different ones of the teeth 5.

The first insulator 11 is provided with a terminal pin base 13 formed integrally by being integrally molded with the first insulator 11, the terminal pin base 13 extending outward in the radial direction thereof. The terminal pin base 13 has a plurality of terminal pines 14 implanted therein. Each of the terminal pins 14 is L-shaped, and has a winding-connection portion formed at one end thereof and a terminal formed at the other end thereof. The winding-connection portion extends in the axial direction, and the terminal extends outward in the radial direction. The terminal pin base 13 has grooves 13a in which the terminals of the above-described terminal pins 14 are placed. The terminals of the terminal pins 14 are exposed in the interiors of the grooves 13a.

The respective winding terminals of the windings 6 (the excitation windings and the detection windings) are coupled and electrically connected to the terminal pins 14 at corresponding positions. Examples of a procedure for the connection include electrically connecting each of the winding terminal and the corresponding terminal pin by having them welded together through tungsten inert gas (TIG) welding. Obviously, applicable procedures for the connection are not limited thereto, and include any procedure that allows them to be electrically connected to each other.

As illustrated in FIG. 1, the opposite sides (upper surface and lower surface) of the annular stator 2 in the axial direction thereof are covered with the resin layers 15. The resin layers 15 are formed in the following manner. First, the first insulator 11 and the second insulator 12 are assembled to the stator core 3 (see FIG. 3) after the surface treatment layer 8 (see FIG. 4) is formed thereon. Subsequently, the respective windings 6 are wound around all of the teeth 5 (see FIG. 3) with the insulator 4 (the first insulator 11 and the second insulator 12) interposed between each of the windings 6 and a corresponding one of the teeth 5, and the winding terminals of the windings 6 are connected to the corresponding terminal pins 14. Thus, the state illustrated in FIG. 2 is obtained.

Thereafter, the stator core 3 being in the state in FIG. 2 is set in a mold (not illustrated), and molding resin is injected into the mold, so that the resin layers 15 are formed. These resin layers 15 formed of molding resin covers the windings 6 and portions of the terminal pins 14 that have the winding terminals thereof connected. Thus, the terminal pins 14 that are electrically connected to the winding terminals of the windings 6 are sealed within the resin layer 15. As illustrated in FIG. 4, the resin layers 15 cover one end and the other end sides of the stator core 3 in the axial direction thereof, and the windings 6 and the insulator 4 (the first insulator 11 and the second insulator 12) are also covered with the resin layers 15.

After the formation of the resin layers 15, the stator core 3 having the resin layers 15 formed thereon is taken out of the mold, so that the state illustrated in FIG. 1 is obtained. Subsequently, lead wires (not illustrated) to be used for electrical connection to the outside are connected to the terminals of the terminal pins 14 that are exposed in the interiors of the grooves 13a.

In the state in FIG. 1, parts (coil parts) of the windings 6 that are wound around the respective teeth 5, parts of the windings 6 that are drawn to the terminal pins 14 from the parts thereof wound around the respective teeth 5, and the end parts of the windings 6 that are connected to the terminal pins 14 are sealed within resin that forms the resin layers 15.

In this structure, the terminal pins 14 are sealed inside the resin layers 15, and the terminal pins 14 are thus prevented from being rusted by moisture or from being corroded by a sulfur component contained in automatic transmission fluid (ATF) oil or the like even when the VR resolver 1 is used in an environment in which a corrosive substance is present, that is, an environment into which moisture intrudes or in an environment in which a sulfur component contained in ATF oil or the like is present.

The inner circumferential surface of the stator core 3 facing the rotor (not illustrated) and the outer circumferential surface thereof are not covered with the resin layers 15 formed of molding resin. However, the surface treatment layer 8 (see FIG. 4) formed on the stator core 3 inhibits direct exposure of the stator core 3, thereby providing protection against water. Rusting of the inner circumferential surface and the outer circumferential surface of the stator core 3 can be thus prevented. In addition, moisture does not intrude between the cores that the stator core 3 is composed of. Rusting of the inside of the cores can be thus prevented.

While this embodiment employs a configuration having the surface treatment layer 8 formed on the surface of the stator core 3, another configuration may be alternatively employed in which, instead of the surface treatment layer 8 formed on the surface of the stator core 3, resin layers are formed in a manner such that, with an adhesive applied to the entirety of the stator core 3, resin is caused to infiltrate on the stator core 3 and between the cores stacked on one another. Alternatively, the surface treatment layer 8 may have a multilayer structure such as one including a plated layer and an adhesive layer.

According to the present invention, a resolver that provides excellent protection of windings and is excellent in properties related to environmental durability such as water proofing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A resolver comprising:
a stator core including teeth;
an insulator attached to the stator core;
windings wound around the respective teeth with the insulator interposed between each of the windings and a corresponding one of the teeth;
a terminal pin base formed integrally with the insulator and extending in a radial direction of the resolver;
terminal pins arranged in the terminal pin base and having end parts of the respective windings connected thereto, wherein
a surface treatment layer is formed on a surface of the stator core, and
a resin layer is formed of molding resin that covers the windings and the terminal pins, and the windings and the terminal pins are sealed within the resin layer.

2. The resolver according to claim 1, wherein the surface of the stator core is covered by at least one of the surface treatment layer and the resin layer in a manner that prevents the surface of the stator core from being exposed to the outside.

3. The resolver according to claim 1, wherein the surface treatment layer formed on the surface of the stator core is formed by a method selected from plating, electrodeposition coating, and electrostatic powder coating.

4. The resolver according to claim 1, wherein the surface treatment layer formed on the surface of the stator core is formed of a resin.
